(19) United States
(12) Patent Application Publication
(10) Pub. No.: US 2011/0041500 A1
(43) Pub. Date: Feb. 24, 2011

(54) SUPPLEMENTAL HEATING FOR GEOTHERMAL ENERGY SYSTEM

(76) Inventor: William Riley, Captiva, FL (US)

Correspondence Address: FISH & RICHARDSON P.C. (NY), P.O. BOX 1022, MINNEAPOLIS, MN, 55440-1022, US

(21) Appl. No.: 12/543,958

(22) Filed: Aug. 19, 2009

(51) Int. Cl. F03G 4/02

(52) U.S. Cl. 60/641.3

(57) ABSTRACT

Extracting energy from a naturally-occurring underground hot rock formation includes enabling fluid to flow, at least partially under the influence of gravity, through a fluid injection well to the hot rock formation, converting the kinetic energy of the flowing fluid into electricity, using at least a portion of the generated electricity to preheat the fluid before it reaches the hot rock formation, heating the fluid with the hot rock formation and, subsequently, extracting energy from the heated fluid for use in connection with an application.

### FIELD OF THE INVENTION

This disclosure relates to utilization of geothermal energy and, more particularly, relates to systems and methods for efficiently extracting geothermal energy from an underground hot rock formation.

### BACKGROUND

High-temperature, subterranean rock formations, such as hot dry rock formations, are found in numerous locations throughout the world.

These formations often store large amounts of energy in the form of heat. When ground water percolates down into such formations, the water is heated and may flow to the earth's surface as geysers or hot springs. When the formations are dry, heat may be recovered from them by pumping water down to the formation and heating the water by contact with the formation.

### SUMMARY OF THE INVENTION

In one aspect, a method includes enabling fluid to flow, at least partially under the influence of gravity, through a fluid injection well to an underground hot rock formation. Kinetic energy of the flowing fluid is converted into electricity. At least a portion of the electricity is utilized to preheat the fluid before it reaches the hot rock formation. The fluid is heated with the hot rock formation to produce a heated fluid. Energy is extracted from the heated fluid for use in connection with an application (e.g., an industrial, commercial, residential application, etc.).

In some implementations, preheating the fluid is accomplished with an electrical heater, such as an immersion-type heater with an electrical resistance-type heating element. The electrical heater is thermally coupled to heat the fluid.

According to certain embodiments, converting the kinetic energy of the flowing fluid includes directing the flowing fluid to drive a turbine-generator to produce electricity.

Heating the fluid with the hot rock formation typically includes directing the fluid through a fluid passage that is thermally coupled to the hot rock formation. In a typical implementation, at least part of the fluid passage extends through the hot rock formation between the fluid injection well and a fluid production well. The fluid passage can have a variety of possible configurations. In some implementations, for example, at least a portion of the fluid passage is substantially horizontal. This portion can be long or short. The fluid passage can be U-shaped or V-shaped or have any other configuration that is desirable. In some embodiments, after heating the fluid with the hot rock formation but before extracting heat from the heated fluid, the heated fluid is removed from thermal coupling with the hot rock formation.

The underground hot rock formation can be a naturally-occurring hot dry rock formation that is naturally heated by geothermal energy. For example, such a formation can be between approximately two and six miles beneath the earth's surface.

Extracting the energy from the heated fluid can, in some instances, include utilizing the heated fluid to drive a second turbine-generator and thereby produce electricity for use in connection with the application. In some instances, extracting the energy from the heated fluid can include passing the heated fluid through a heat exchanger.

In another aspect, a system includes an underground hot rock formation, such as a hot dry rock formation. A fluid injection well facilitates fluid flow, at least partially under the influence of gravity, to the hot rock formation. A turbine-generator is arranged to convert kinetic energy of the flowing fluid into electricity. One or more electrical heaters use at least a portion of the electricity to preheat the fluid before it reaches the hot rock formation. The preheated fluid absorbs heat from the hot rock formation to produce a heated fluid for use in connection with an application.

In some implementations, the system includes a fluid production well that facilitates flow of the heated fluid away from and out of thermal contact with the hot rock formation. A pump can be provided to urge the heated fluid away from the hot rock formation through the fluid production well.

Typical embodiments include a fluid passage that extends at least partially through the hot rock formation between the fluid injection well and the fluid production well. The fluid passage can have a variety of possible configurations. In some implementations, for example, at least a portion of the fluid passage is substantially horizontal. This portion can be long or short. Additionally, in some implementations, the fluid passage can be U-shaped, V-shaped or have any other convenient configuration that is desirable. In some instances, the fluid passage can include multiple fractures formed in the hot dry rock formation.

The electrical heater can be an immersion-type electrical heater with an electrical resistance-type heater element or any other type of electrical heater device.

A typical system includes a heat utilization device, typically located above the earth's surface, to utilize heat from the heated fluid. The heat utilization device can be a heat exchanger that extracts heat from the heated fluid with one or more secondary fluids. The heat utilization device can be a second turbine-generator, in which case, the heated fluid may drive the second turbine-generator to produce electricity.

In some implementations, the system includes an electrical distribution panel to distribute the electricity produced by the turbine-generator to the one or more electrical heaters.

Typically, the hot rock formation is a naturally-occurring hot dry rock formation located between about two and six miles beneath the earth's surface and is naturally heated by geothermal heat.

In yet another aspect, a system includes an underground hot rock formation and a fluid injection well that facilitates fluid flow, at least partially under the influence of gravity, to the hot rock formation. A turbine-generator is arranged to convert kinetic energy of the flowing fluid into electricity. An electrical heater uses at least a portion of the electricity to preheat the fluid before it reaches the hot rock formation. The preheated fluid absorbs heat from the hot rock formation to produce a heated fluid for use in connection with an application. A fluid production well facilitates flow of the heated fluid away from the hot rock formation and a fluid passage that extends at least partially through the hot rock formation between the fluid injection well and the fluid production well.

The fluid passage can have a variety of possible configurations. In some implementations, for example, at least a portion of the fluid passage is substantially horizontal. This portion can be long or short. Additionally, in some implementations, the fluid passage can be U-shaped, V-shaped or have any other convenient configuration that is desirable. In some instances, the fluid passage can include multiple fractures formed in the hot dry rock formation.

In some implementations, one or more of the following advantages are present.

For example, large amounts of geothermal energy can be drawn from naturally-occurring underground hot rock formations in a highly efficient manner. This energy can be harnessed in an environmentally-friendly manner and utilized in connection with any type of domestic, commercial, industrial or other application that uses heat.

Moreover, the systems disclosed herein are relatively inexpensive to build. This is because the techniques disclosed herein reduce the need to dig as deep as otherwise would be required to extract a given amount of energy. This reduces the complexity and amount of drilling that is required to build these systems. As a result, the cost of building these systems, including drilling holes from the earth's surface to and through the hot rock formation, is lower.

Other features and advantages will be apparent from the description and drawings, and from the claims.

### BRIEF DESCRIPTION OF THE DRAWINGS

FIG. 1 is a cross-sectional elevation view of a geothermal energy system.

FIG. 2 is a cross-sectional elevation view of another geothermal energy system.

FIG. 3 is a cross-sectional elevation view of yet another geothermal energy system.

### DETAILED DESCRIPTION OF THE DRAWINGS

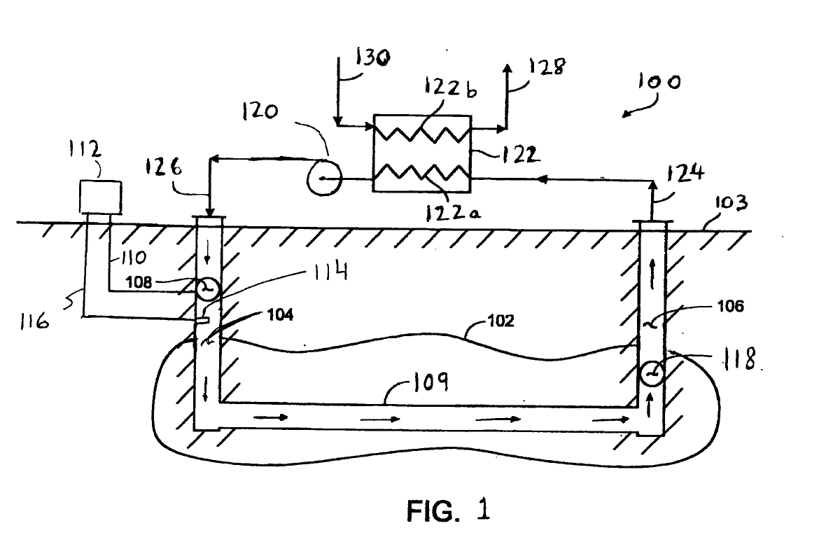

FIG. 1 is a schematic diagram of a geothermal energy system 100 adapted to draw thermal energy from an underground hot rock formation 102 in an environmentally-friendly and cost-efficient manner.

In the illustrated system 100, the hot rock formation 102 is a hot dry rock formation, which is a naturally-occurring subsurface rock formation that is heated by geothermal energy. Hot dry rock formations typically are found between about two and six miles beneath the earth's surface 103. In a typical implementation, the temperature of a hot dry rock formation is well above the temperature at the earth's surface. In some instances, the temperature may well exceed 100 degrees Centigrade. Of course, such deep geothermal locations can vary widely in depth and temperature.

In the illustrated system 100, a substantially vertical fluid injection well 104 extends between the earth's surface 103 and a first section of the hot rock formation 102. A substantially vertical fluid production well 106 extends between the earth's surface 103 and a second section of the hot rock formation 102 that is different than the first.

The fluid injection well 104 and the fluid production well 106 are some distance apart from one another. As illustrated, the bottom sections of the fluid injection well 104 and the fluid production well 106 extend into approximately opposite ends of the hot rock formation 102. Each of the bottom sections is thereby thermally coupled to the hot rock formation 102 so that fluid inside the bottom sections can absorb geothermal energy in the form of heat from the surrounding hot rock formation 102.

A substantially horizontal passage 109 extends through the hot rock formation 102 between the bottom sections of the fluid injection well 104 and the fluid production well 106. In the illustrated implementation, the entire horizontal passage 109 is contained within and thermally coupled to the hot rock formation 102.

In some implementation, the fluid production well's 106 cross-sectional diameter may be larger than the fluid injection well's 104 cross-sectional diameter. This can helps accommodate the expansion of fluid that occurs as the fluid passes through the subterranean portions of the system 100 and absorbs heat.

In general, the fluid injection well 104, the fluid production well 106 and the substantially horizontal passage 109 should be sufficiently large and, therefore, have sufficient fluid carrying capacities to accommodate a substantially steady flow of fluid and to accommodate the system components therein.

In some implementations, one or more turbine-generators can be coupled to the fluid injection well 104 so that their turbines can extract kinetic energy from the fluid flowing downward through the fluid injection well 104. These turbine-generators can be staged at various elevations. In the illustrated system, however, one turbine-generator 108 is coupled to the fluid injection well 104 in that manner. The extracted kinetic energy is used to drive the generator portion of the turbine-generator to produce electricity. In the illustrated implementation, the turbine-generator 108 is at an elevation beneath the earth's surface 103 but above the upper boundary of the hot rock formation 102.

In general, the turbine-generator 108 can be positioned at any elevation that enables the turbine-generator 108 to convert the kinetic energy of the flowing fluid being delivered to the hot rock formation 102 into electricity. This includes the possibilities of being located above the earth's surface or within the hot rock formation 102 itself. It is generally desirable, however, that the turbine-generator 108 be located as low as practical in the fluid injection well 104 so that the fluid flowing through the turbine-generator 108 will have fallen a great distance and, therefore, gained a large amount of kinetic energy. The turbine-generator 108 should not, however, be so low in the fluid injection well 104 that an undue risk exists that static fluid may accumulate in the bottom of the fluid injection well 104 to a level that would unduly impede fluid flow through the turbine-generator 108.

The turbine-generator 108 is electrically coupled, via electrical bus 110, to supply the electricity it produces to an electrical distribution panel 112, which is located above the earth's surface 103. In the illustrated implementation, the electrical bus 110 extends through the earth from the turbine-generator 108 to the electrical distribution panel 112.

In a typical embodiment, the electrical distribution panel 112 is adapted to distribute the electricity it receives from the turbine-generator 108 (or from other sources) to a variety of electrical loads, including one or more electrical heaters (e.g., electrical heater 114 shown in FIG. 1) thermally coupled to the fluid injection well 104 to heat fluid flowing through the fluid injection well 104. More particularly, in the illustrated implementation, an electrical heater 114 extends from a side wall of the fluid injection well 104 directly into the injection well's fluid flow path.

As illustrated, distribution panel 112 is electrically coupled to the electrical heater 114 via electrical bus 116, which passes from the distribution panel 112 to the electrical heater 114, through the earth.

In the illustrated system 100, the electrical heater 114 is at an elevation in the fluid injection well between the turbine-generator 108 and the upper portion of the hot rock formation 102. In a typical implementation, however, the electrical heater 114 (or heaters) can be placed at any elevation that enables it to assist the hot rock formation 102 to heat or preheat the fluid. For example, in certain embodiments, the electrical heater 114 (or heaters) may be above the turbine-generator 108, at the same elevation as the turbine-generator 108, or even below the upper boundary of the hot rock formation 102.

Some implementations include multiple electrical heaters, each being arranged to assist the hot rock formation 102 in heating the fluid. These heaters can be arranged in a variety of ways. For example, they can located close together or far apart from one another. Several of the electrical heaters can be at approximately the same elevation as one another, one or more of the heaters can be above the earth's surface and one or more of the heaters can be at an elevation below the upper boundary of the hot rock formation 102.

The electrical heater 114 (or heaters) can be any type of heater or system that is adapted to convert electricity into thermal energy/heat that can be used to heat a flowing fluid (e.g., water flowing through the fluid injection well 104). In a typical implementation, the electrical heater 114 is an immersion-type heater with an electrical resistance-type heater element.

A production pump 118 is arranged in the fluid production well 106. The production pump 118 is optional too since, in some implementations, the fluid flashes into steam as it passes through the hot rock formation 102 and the steam rises naturally in the fluid production well 106. If provided, the production pump 118 generally is arranged to urge the heated fluid from the hot rock formation 102 up through the fluid production well 106 to a location above the earth's surface 103. In the illustrated implementation, the production pump 118 is at an elevation near the bottom of the fluid production well 106.

In general, whether a production pump (e.g., production pump 110 in system 100) is required can depend on the phase (liquid or vapor) of the heated fluid. If, during system operation, the heated fluid exists substantially as a vapor, then a production pump may not be necessary. If, on the other hand, during system operation, the heated fluid exists at the production pump's location substantially as a liquid, then the production pump may be considered desirable to facilitate flow out of the production well 106.

Whether the fluid in the fluid production well 106 is substantially liquid or substantially vapor may depend, among other things, on the temperature of the hot rock formation 102, the distance between wells 104, 106, the physical configuration of the fluid passages, the rate of fluid flow through the passages, the depth of the wells 104 and 106, and the pressure near the bottom of the fluid production well 106.

A heat utilization device 122 is located above the earth's surface 103 and is fluidly coupled, as shown, to both the fluid injection well 104 and the fluid production well 106. The heat utilization device 122 can be any type of device that can utilize heat from the heated fluid exiting the fluid production well 106.

In the illustrated implementation, the heat utilization device 122 is a dual-circuit heat exchanger that includes a primary fluid circuit 122a carrying the heated fluid and a secondary fluid circuit 122b carrying a second fluid to be heated by the primary fluid. The primary 122a and secondary 122b fluid circuits are thermally coupled to one another so that heat from fluid flowing in the primary fluid circuit 122a can be transferred to the fluid flowing in the secondary fluid circuit 122b. The heated secondary circuit fluid exits the heat exchanger 122 for use in connection with some domestic, commercial, industrial or other use, such as domestic heating.

A first set of connecting pipes 124, 126 extends between the heat utilization device's primary fluid circuit 122a and the fluid injection and fluid production wells 104, 106, respectively. A second set of pipes 128, 130 extends from the heat utilization device's secondary fluid circuit 122b to an external device or devices (not illustrated).

During system 100 operation, fluid circulates continuously through the fluid circuit that comprises the fluid injection well 104, the substantially horizontal passage 109, the fluid production well 106 the above-ground connective piping to and from the heat utilization device 122 and through the primary fluid circuit 122a of the heat utilization device 122.

More particularly, in the illustrated system 100, relatively cool fluid flows downward in the fluid injection well 104 at least substantially under the influence of gravity. The turbine-generator converts the kinetic energy of the flowing fluid into electricity, at least part of which is used to power the electrical heater 114. As the fluid flows through the fluid injection well 104, the fluid absorbs heat from the electrical heater(s) 114, from the earth surrounding the fluid injection well 104 and eventually from the hot rock formation 102 surrounding the bottom section of the fluid injection well 104.

The flowing fluid continues to absorb heat from the hot rock formation 102 as it flows through the horizontal passage 109 and as it turns upward into the fluid production well 106. The pump 118 within the fluid production well 106 urges the heated fluid to flow up the fluid production well 106 to the connecting pipe that runs from the fluid production well to the heat utilization device 122.

The amount of heat that the fluid absorbs depends, inter alia, on the power rating, number of and placement of the electrical heater(s) 114, the temperature of the hot rock formation 102, the length of the portion of the subterranean passage that is thermally coupled to the hot rock formation, the physical configuration (e.g., size) of that portion, and the rate of fluid flow through the system.

The heated fluid then flows through the primary fluid circuit 122a of the heat utilization device 122 while a lower temperature secondary fluid flows through the secondary fluid circuit 122b of the heat utilization device 122. The primary and secondary fluid circuits are arranged so that heat from the heated fluid in the primary circuit is transferred to the fluid in the secondary fluid circuit.

The heated secondary circuit fluid from the heat utilization device's secondary fluid circuit 122b is delivered through a connecting pipe away from the heat utilization device 122 for use in connection with a domestic, commercial, industrial or other use. In some implementations, the secondary circuit fluid is heated by the primary circuit fluid to the point of flashing (e.g., to steam), which may be used, for example, to motivate a turbine-generator to generate electricity.

Once heat is extracted from the fluid flowing through the primary circuit of the heat utilization device, that fluid returns to the fluid introduction well 104 via pipe 126.

Make-up fluid may be added to the system 100, for example, at a connection provided on at point in the system to replace water lost by leakage.

In the illustrated system, the electrical heater 114 advantageously enables the system 100 to produce a desired fluid temperature, for example at the outlet of the fluid production well 106, with a shorter path through the hot rock formation 102 than would be required without the electrical heater 114. Since the electrical heater 114 preheats the fluid before the fluid reaches the hot rock formation 102, the fluid needs to absorb less heat from the hot rock formation to reach the desired temperature.

Accordingly, in a system that includes an electrical heater 114, the same fluid output temperature (measured, for example, near the outlet of the fluid production well 106) may be reached with a shorter horizontal passage 109 (or shallower fluid injection and production wells 104, 106) than would be required without the heater 114. Reducing the length of the path needed through the hot rock formation 102 significantly reduces the difficulty and cost associated with creating such a passage 109. This is particularly significant in systems 100 where the hot rock formation 102 is located very far below the earth's surface 103.

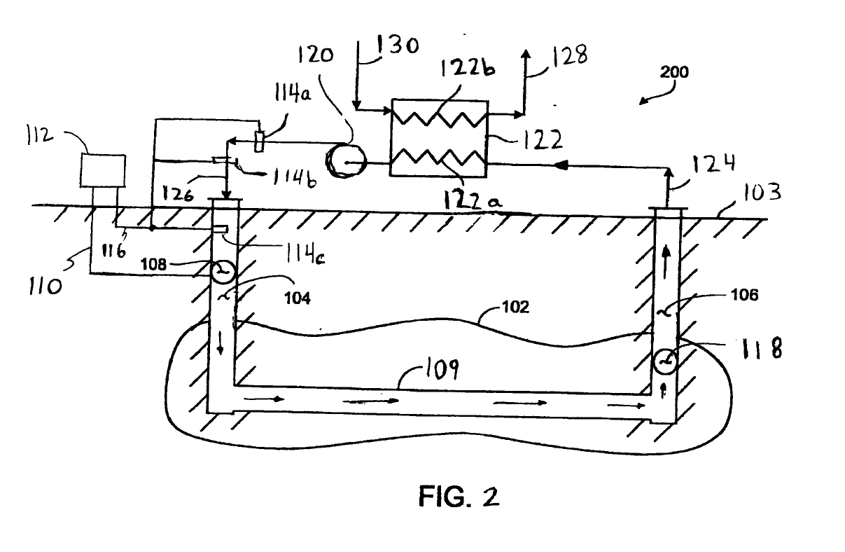

The system 200 of FIG. 2 is similar to the system 100 of FIG. 1 except that, in the system 200 of FIG. 2, multiple electrical heaters 114a, 114b and 114c are located upstream of the turbine-generator 108 and extend into the fluid flow stream.

Providing multiple electrical heaters 114a-114c is one way to potentially increase the amount of pre-heating that the fluid experiences before it reaches a point where it is thermally coupled to the hot rock formation 102. Increasing the amount of pre-heating generally reduces the length that the portion of the flow path that is thermally coupled to the hot rock formation 102 needs to be in order for the system to produce a desired fluid temperature (e.g., at the outlet of the fluid production well 106).

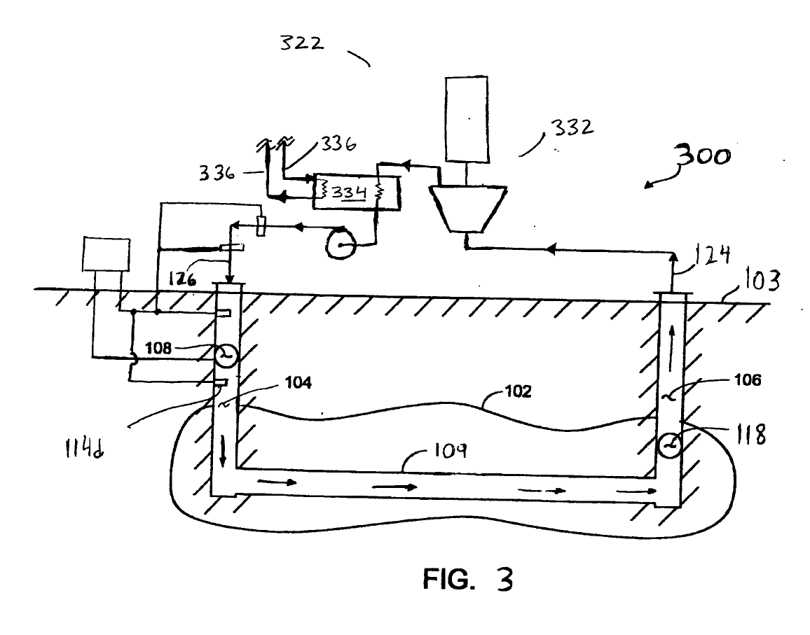

The system 300 of FIG. 3 is similar to the system 200 of FIG. 2 except that: (1) the system 300 of FIG. 3 has an additional electrical heater 114d located downstream of the turbine-generator 108 in the fluid injection well 104; and (2) the heat utilization device 322 in the system 300 of FIG. 3 includes a turbine-generator 332 with a condenser 334 coupled to the turbine-generator 332.

In the illustrated implementation, the turbo-generator 332 is located above the earth's surface and is fluidly-coupled to the fluid production well 106 as shown. The heated fluid exiting the fluid production well 106 is directed to flow through the turbine portion of the turbine-generator 332 and drives the turbine-generator 332 to produce electricity. The fluid then flows into the condenser where it is cooled by cooling water flowing through cooling water circuit 336.

The electricity produced by turbine-generator 332 can be distributed to an electrical distribution system, which, in some implementations, can deliver electricity to the electrical heaters 114a-114d.

A number of embodiments of the invention have been described. Nevertheless, it will be understood that various modifications may be made without departing from the spirit and scope of the invention.

For example, in some implementations the fluid that flows through the hot rock formation fluid circuit is water. However, other fluids, particularly relatively low-boiling temperature fluids, such as bromine-based fluids, may be suitable as well. Another fluid that has a relatively low boiling point and that may be usable is ethanol (alcohol), which also may be easier to handle than bromine. In certain implementations, it may be desirable that such fluids be environmentally-friendly and benign. It is generally desirable, and particularly so in systems where less environmentally-friendly or benign fluids are used, to provide safety measures to minimize the risk and potential hazards of fluid leaks.

Low boiling point temperature fluids tend to vaporize easily when they are heated by the electrical heaters and the hot rock formation. The vaporized fluid then flows naturally up through the production well without the need for a production pump. Eliminating the need for a production pump could result in a savings of energy and associated energy-production, system-manufacturing and system-operating costs. Moreover, the ease with which the vaporized fluid flows up through the production well can enhance the fluid flow through the system.

Additionally, some systems may include multiple fluid injection wells and/or multiple fluid production wells. Moreover, the number of fluid injection wells and fluid production wells may not be identical. In some implementations, multiple turbine-generators may be arranged to convert kinetic energy of fluid flowing throughout one or more fluid injection wells. Multiple turbine-generators may be located at different heights in a single fluid injection well.

The heat fluid produced by a system may be used in connection with any domestic, commercial, industrial or other application that uses heat.

Returning the fluid from the heat utilization device back to the fluid injection port is optional. In some instances, fluid may not be circulated back into the fluid introduction well after the heat has been extracted by the heat utilization device.

The boreholes and/or passages in or near the hot dry rock formation may be formed in any convenient shape or configuration. They could be substantially straight, angled, curved or include various turns. In general, the arrangement of boreholes and passages should provide the fluid flowing within the opportunity to absorb heat from the underground hot rock formation.

Any underground source of heat (e.g., hot dry rock, hot wet rock, etc.) may be suitable to provide heat to the fluid flowing through the wells and/or passages.

The design of the turbine-generator(s) 108 may vary as may the design of the various pump(s) vary. The pump(s), for example, may be centrifugal pumps or positive displacement pumps. The system may include a variety of valve arrangements to help control the flow of fluid through the system. The system also may include a control system adapted to control various aspects of the system's operation, including electrical aspects and fluid flow aspects.

The fluid can be water or any other fluid. In some instances, the fluid can have a relatively low boiling point. The pipes described herein can be any kind of conduit or channel adapted to carry fluid.

In certain instances, one or more of the wells may be configured such that they are not in direct physical contact with the hot rock formation. Similarly, the substantially horizontal passage may be close to, but not actually passing through, the hot rock formation. Additionally, there can be portions of the substantially horizontal passage that are not in contact with (and possibly not even thermally coupled to) the hot rock formation.

In some implementations, the system can include multiple substantially horizontal passages that extend between one or more pairs of injection and production wells. In some implementations, the substantially horizontal passages can simply comprise multiple fractures that extend between the fluid injection and fluid production wells.

The domestic, commercial, industrial or other applications in which the extracted heat may be utilized can vary greatly. Indeed, such applications can include the application of heated fluid to any useful purpose.

The electrical heaters could be located anywhere in the system that is convenient to help produce a desired fluid temperature. In some implementations, an electrical heater can be positioned downstream of the hot rock formation (e.g., in the fluid production well).

In some embodiments, the injection well, the production well or both may be partially or entirely thermally insulated.

Other types of heaters may be used as well, including heaters that use the electricity generated by the turbine-generator indirectly to preheat the fluid to be heated subsequently by the hot rock formation.

Moreover, the electrical heaters can be thermally coupled to heat the fluid in a number of ways. For example, as described above, the electrical heaters can extend into the fluid flow path. Alternatively, the electrical heaters can be wrapped around or positioned near the outside of a fluid flow pipe or conduit.

The electrical distribution panel may have controls that enable a system operator to control various aspects of the system's operations.

The physical arrangement of components relative to one another can vary.

Accordingly, other implementations are within the scope of the following claims.

What is claimed is:

1. A method comprising:
enabling fluid to flow, at least partially under the influence of gravity, through a fluid injection well to an underground hot rock formation;
converting kinetic energy of the flowing fluid into electricity;
utilizing at least a portion of the electricity to preheat the fluid before it reaches the hot rock formation;
heating the fluid with the hot rock formation to produce a heated fluid; and
extracting energy from the heated fluid for use in connection with an application.

2. The method of claim 1 wherein preheating the fluid is accomplished with an electrical heater that is thermally coupled to heat the fluid.

3. The method of claim 2 wherein the electrical heater is an immersion-type heater with an electrical resistance-type heating element.

4. The method of claim 1 wherein converting the kinetic energy of the flowing fluid comprises:
directing the flowing fluid to drive a turbine-generator.

5. The method of claim 1 wherein heating the fluid with the hot rock formation comprises:
directing the fluid through a fluid passage that is thermally coupled to the hot rock formation.

6. The method of claim 5 wherein the fluid passage extends at least partially through the hot rock formation between the fluid injection well and a fluid production well, and
wherein at least a portion of the fluid passage is substantially horizontal.

7. The method of claim 1 further comprising:
after heating the fluid with the hot rock formation but before extracting heat from the heated fluid, removing the heated fluid from thermal coupling with the hot rock formation.

8. The method of claim 1 wherein the underground hot rock formation is a naturally-occurring hot dry rock formation that is naturally heated by geothermal energy.

9. The method of claim 8 wherein the underground hot dry rock formation is between approximately two and six miles beneath the earth's surface.

10. The method of claim 1 wherein extracting the energy from the heated fluid comprises:
utilizing the heated fluid to drive a second turbine-generator and thereby produce electricity for use in connection with the application.

11. The method of claim 1 wherein extracting the energy from the heated fluid comprises:
passing the heated fluid through a heat exchanger.

12. A system comprising:
an underground hot rock formation;
a fluid injection well that facilitates fluid flow, at least partially under the influence of gravity, to the hot rock formation;
a turbine-generator arranged to convert kinetic energy of the flowing fluid into electricity; and
an electrical heater to use at least a portion of the electricity to preheat the fluid before it reaches the hot rock formation,
wherein the preheated fluid absorbs heat from the hot rock formation to produce a heated fluid for use in connection with an application.

13. The system of claim 12 further comprising:
a fluid production well that facilitates flow of the heated fluid away from the hot rock formation.

14. The system of claim 13 further comprising:
a pump to urge the heated fluid away from the hot rock formation through the fluid production well.

15. The system of claim 13 further comprising:
a fluid passage that extends at least partially through the hot rock formation between the fluid injection well and the fluid production well,
wherein at least a portion of the fluid passage is substantially horizontal.

16. The system of claim 15 wherein the fluid passage comprises a plurality of fractures in the hot dry rock formation.

17. The system of claim 12 wherein the electrical heater is an immersion-type electrical heater that comprises an electrical resistance-type heater element.

18. The system of claim 12 further comprising:
a heat utilization device to utilize heat from the heated fluid.

19. The system of claim 18 wherein the heat utilization device is a heat exchanger to extract heat from the heated fluid with a secondary fluid.

20. The system of claim 18 wherein the heat utilization device is a second turbine-generator, and
wherein the heated fluid drives the second turbine-generator to produce electricity.

21. The system of claim 12 further comprising:
an electrical distribution panel to distribute the electricity produced by the turbine-generator to the electrical heater.

22. The system of claim 12 wherein the hot rock formation is a naturally-occurring hot dry rock formation located between about two and six miles beneath the earth's surface.

23. A system comprising:
an underground hot rock formation;
a fluid injection well that facilitates fluid flow, at least partially under the influence of gravity, to the hot rock formation;
a turbine-generator arranged to convert kinetic energy of the flowing fluid into electricity;
an electrical heater to use at least a portion of the electricity to preheat the fluid before it reaches the hot rock formation, wherein the preheated fluid absorbs heat from the hot rock formation to produce a heated fluid for use in connection with an application;
a fluid production well that facilitates flow of the heated fluid away from the hot rock formation; and
a fluid passage that extends at least partially through the hot rock formation between the fluid injection well and the fluid production well, wherein at least a portion of the fluid passage is substantially horizontal.
